(19) United States
(12) Patent Application Publication
(10) Pub. No.: US 2024/0139874 A1
(43) Pub. Date: May 2, 2024

(54) LASER WELDING PENETRATION MONITORING

(71) Applicant: JAGUAR LAND ROVER LIMITED, Whitley, Coventry, Warwickshire (GB)

(72) Inventors: Oliver BAILEY, Coventry, Warwickshire (GB); Mo AL-BADANI, Coventry, Warwickshire (GB)

(21) Appl. No.: 18/550,916

(22) PCT Filed: Mar. 31, 2022
(86) PCT No.: PCT/EP2022/058682

§ 371 Date: Sep. 15, 2023

(30) Foreign Application Priority Data
Mar. 31, 2021 (GB) 2104570.3

(51) Int. Cl. B23K 26/21; B23K 26/03; B23K 26/064; B23K 26/70

(52) U.S. Cl. CPC B23K 26/21; B23K 26/032; B23K 26/064; B23K 26/70; B23K 2101/36

(57) ABSTRACT

A laser beam welding system comprises a welding laser source and a penetration monitoring laser source arranged for simultaneous operation in a manner such that a penetration monitoring laser beam from the penetration monitoring laser source is incident on a molten weld pool at a process site comprising an area of contact between a connection tab and a cell terminal, the connection tab and cell terminal to be joined by the welding system, and wherein the molten weld pool is created by a welding laser beam emitted by the welding laser source. The penetration monitoring laser beam is reflected from the molten weld pool to a receiver arranged to receive the reflected penetration monitoring laser beam. Data is outputted indicative of the distance travelled by the penetration monitoring laser beam and therefore the penetration of the welding laser beam at the process site.

### TECHNICAL FIELD

The present disclosure relates to laser welding penetration monitoring. Aspects of the invention relate to a laser beam welding system, a laser beam welding method, a controller, a computer program, a non-transitory computer readable storage medium and a signal.

### BACKGROUND

The current method of monitoring weld quality when laser welding busbar connector tabs to cells of a battery assembly is metallographic examination. Typically, the first and the last welded part are sent for destructive analysis. If either part fails inspection, the plant quarantines all parts, pending investigation. This process tends to cause delays in production, is of limited value in analysing weld quality (due to the necessarily low sample size by comparison with the total number of welds) and gives rise to excess waste.

It is an object of embodiments of the invention to at least mitigate one or more of the problems of the prior art.

### SUMMARY OF THE INVENTION

Aspects and embodiments of the invention provide a laser beam welding system, a laser beam welding method, a controller, a computer program, a non-transitory computer readable storage medium and a signal as claimed in the appended claims.

According to an aspect of the invention there is provided a laser beam welding system comprising:
a welding laser source; and
a penetration monitoring laser source,
arranged for simultaneous operation in a manner such that a penetration monitoring laser beam from the penetration monitoring laser source is incident on a molten weld pool at a process site comprising an area of contact between a connection tab and a cell terminal, the connection tab and cell terminal to be joined by the welding system, and wherein the molten weld pool is created by a welding laser beam emitted by the welding laser source.

According to another aspect of the invention there is provided a laser beam welding system comprising:
a welding laser source; and
a penetration monitoring laser source,
arranged for simultaneous operation in a manner such that a penetration monitoring laser beam from the penetration monitoring laser source is incident on a molten weld pool at a process site comprising an area of contact between a connection tab and a cell terminal, the connection tab and cell terminal to be joined by the welding system, and wherein the molten weld pool is created by a welding laser beam emitted by the welding laser source, and the penetration monitoring laser beam being reflected from the molten weld pool to a receiver arranged to receive the reflected penetration monitoring laser beam and in accordance therewith, determine, or output data indicative of, the distance travelled by the penetration monitoring laser beam and therefore the penetration of the welding laser beam at the process site.

The use of the penetration monitoring laser beam in conjunction with the welding laser beam may provide in process, optionally real-time, monitoring of the welding depth of the welding laser beam. This may allow improve response time and/or reduce wastage involved in alternative weld quality analysis methods e.g. destructive testing or resistance measurement. Specifically, the penetration monitoring laser beam, which may be of sufficiently low power as not to interact (e.g. provide any significant heating) with the process site, may act as a measuring tool to determine the location in space of the weld pool and therefore the depth to which the welding laser beam is penetrating. The connection tab may be position over the cell terminal, such that the welding laser beam penetrates through the connection tab into the cell terminal. A first surface of the connection tab may be in contact with the cell terminal and the system may be arranged to direct the welding laser beam and penetration monitoring laser beam at a second surface of the connection tab. The first and second surfaces may be opposite.

In some embodiments the welding system comprises a common optical system comprising at least one mirror, wherein each of the at least one mirror is arranged to redirect both the welding laser beam and the penetration monitoring laser beam in their paths to the process site. The common optical system may facilitate the application of similar optical adjustments (e.g. reflection angles and/or focussing) to the welding laser beam and the penetration monitoring laser beam. This may mean that the penetration monitoring laser beam can more simply, accurately and/or reliable have a nominal spot position relative to a spot position of the welding laser beam. This may be advantageous given the desirability of accurately locating the spot position of the penetration monitoring laser beam at the site of the molten weld pool.

In some embodiments the receiver is arranged to receive the reflected penetration monitoring laser beam with it having been reflected from the molten weld pool and then reflected by the one, some or all of the mirrors of the common optical system. Using one, some or all of the mirrors of the common optical system for a return path of the penetration monitoring laser beam may be advantageous as the penetration monitoring laser beam may be naturally and/or advantageously reflected along such a path from the molten weld pool. It may also eliminate the need to provide an additional optical system for the return path of the penetration monitoring laser beam.

In some embodiments at least one of the mirrors of the common optical system has a surface finish which comprises a fused silica coating.

Conventionally, one or more mirrors used to control the path of such a welding laser beam are coated with silicon carbide. Silicon carbide offers high levels of reflective efficiency of infra-red light, which may be considered desirable in an optical system for redirecting an infra-red welding laser beam to a process site. Additionally, silicon carbide offers low levels of back-reflection, the term back reflection being used here to refer to laser light which is dispersed and/or absorbed within the relevant optical system component. Such back-reflection may cause damage to components by for instance heating and cracking them. Thus, low levels of back-reflection may again be considered desirable in an optical system for redirecting an infra-red laser beam to a process site. However, silicon carbide coatings may have relatively poor reflective efficiency in wavebands which may be favoured for the penetration monitoring laser beam. Such coatings may therefore be undesirable with respect to the use of the penetration monitoring laser beam, in that it may be desired for the reflected penetration monitoring laser beam to be reflected by the one, some or all of the mirrors of the common optical system in order to reach the receiver. Consequently, it is envisaged that a surface finish having a relatively low reflective efficiency for infra-red light (e.g. lower than that of silicon carbide) may be used for the surface finish (e.g. in the form of a coating), especially where the surface finish has a relatively high reflective efficiency for wavebands favoured for the penetration monitoring laser beam (e.g. higher than silicon carbide). Potential damage which might otherwise be caused by back-reflection of the infra-red welding laser beam in view of the lack of silicon carbide (or similar e.g. silicon coating) surface finish may be mitigated by various factors discussed further below.

In some embodiments at least one of the mirrors of the common optical system has a fused silica coating. A coating such as fused silica, which does not have high reflective efficiency in the infra-red waveband, may be used in place of a coating such as silicon carbide.

In some embodiments the welding system is arranged such that the distance between the nearest of the mirrors of the common optical system to the process site and the process site is greater than approximately 300 mm. In some embodiments the distance may be between 300 and 350 mm. Such distances, may assist in mitigating damage as discussed above where a silicon carbide coating is omitted.

In some embodiments the welding laser source is arranged to deliver the welding laser beam in a discontinuous manner. Deliveries in a discontinuous manner may mitigate damage as discussed above where a silicon carbide coating is omitted. It may be for instance that the welding laser beam is delivered in periodic bursts, for instance with a period of substantially 80 ms or less.

In some embodiments the welding laser source is arranged to deliver the welding laser beam at a power of less than approximately 1 kW. In some embodiments the power is between approximately 500 W and 1 kW. In some embodiments the power is between approximately 500 W and 800 W. In some embodiments the power is between approximately 550 W and 650 W.

In some embodiments at least one of the mirrors of the common optical system comprises an adjustable mirror arranged to be selectively adjustable to alter the position of the process site. The adjustable mirror may be used for steering the welding laser beam in order that it perform of a continuous welding operation and/or for re-siting of the welding laser beam e.g. as may be appropriate when commencing a new continuous welding operation at a new location. As will be appreciated, the adjustable mirror may also have a similar steering effect on the penetration monitoring laser beam. Providing a corresponding steering effect on the penetration monitoring laser beam may be advantageous where it is desired to maintain the spots of the respective beams at consistent positions with respect to each other despite the positional adjustment occurring.

In some embodiments the at least one adjustable mirror comprises at least one of an X-axis adjustment mirror arranged to be selectively adjustable to alter the position of the process site in an X-axis direction and a Y-axis adjustment mirror arranged to be selectively adjustable to alter the position of the process site in a Y-axis direction. By tilting each of the at least one adjustable mirrors about a single axis of rotation a positional adjustment in a single plane to be accomplished. By combining two such mirrors each arranged to tilt about axes of rotation that are perpendicular to each other, positional adjustment within a plane (i.e. X-axis and Y-axis) may be achieved.

In some embodiments the common optical system comprises at least one lens wherein each of the at least one lens is arranged to adjust both the welding laser beam and the penetration monitoring laser beam in their paths to the process site.

In some embodiments the receiver is arranged to receive the reflected penetration monitoring laser beam with it having been reflected from the molten weld pool and then having passed through the one, some or all of the lenses of the common optical system. Using one, some or all of the lenses of the common optical system for a return path of the penetration monitoring laser beam may be advantageous as the penetration monitoring laser beam may be naturally and/or advantageously reflected along such a path from the weld pool. It may also eliminate the need to provide an additional optical system for the return path of the penetration monitoring laser beam.

In some embodiments at least one of the lenses of the common optical system comprises an adjustable lens arranged to be selectively adjustable to alter the position of the process site.

In some embodiments the adjustable lens is arranged to adjust the focus of the welding laser beam and the focus of the penetration monitoring laser beam. The adjustable focussing lens may therefore be considered to adjust the position of a spot of the welding laser beam in the Z-axis direction. The system may be arranged to use the adjustable focussing lens to select a desired focus distance for the welding laser beam. Thus, it may be possible to select between options such as focussing the welding laser beam at the process site and focussing it to varying extents beyond the process site such that the spot of the welding laser beam is to some extent unfocussed at the process site. The system may also be arranged to use the adjustable focussing lens to compensate for angular adjustments of the welding laser beam (e.g. as resulting from X-axis and/or Y-axis position adjustments of the welding laser beam) in maintaining the desired focus at the process site. As will be appreciated, the adjustable focussing lens may also have a similar effect on the focus of the penetration monitoring laser beam. Providing a corresponding focussing effect on the penetration monitoring laser beam may be advantageous where it is desired to maintain the spots of the respective beams at consistent focus distances with respect to each other despite any positional adjustments occurring.

In some embodiments the common optical system is arranged to produce a weld path of the welding laser beam which is a continuous loop. The continuous loop may be completed in a clockwise direction.

In some embodiments the common optical system is arranged to produce oscillations about the weld path, wherein the oscillations comprise a first component in a direction parallel to the weld path and a second component in a direction normal to the weld path.

In some embodiments the welding system comprises a penetration monitoring laser optical system in addition to the common optical system and the penetration monitoring laser beam passes through the penetration monitoring optical system on its path to the process site. The penetration monitoring laser optical system may therefore allow optical conditioning of the penetration monitoring laser beam in addition to that provided by the common optical system. This may be desirable where for instance the position and/or the focus of a spot of the penetration monitoring laser beam at the process site as would be determined by the common optical system alone would be undesirable.

In some embodiments the penetration monitoring laser optical system is arranged to allow selective positional adjustment of the penetration monitoring laser beam at the process site independently of the positioning of the process site as defined by the welding laser beam. Thus, the penetration monitoring laser optical system may be adjustable to provide control over variation in the optical conditioning it provides. The penetration monitoring laser optical system may therefore allow positional adjustment of a spot of the penetration monitoring laser beam relative to a spot of the welding laser beam despite both beams passing through the common optical system. This may be desirable where for instance the weld path of the welding laser beam changes direction and so the location of the weld pool created by the welding laser beam changes with respect to the position of a spot of the welding laser beam.

In some embodiments the receiver is arranged to receive the reflected penetration monitoring laser beam with it having been reflected from the molten weld pool and then passing through the penetration monitoring laser optical system. Using the penetration monitoring laser optical system for a return path of the penetration monitoring laser beam may be advantageous as the penetration monitoring laser beam may be naturally and/or advantageously reflected along such a path from the weld pool. It may also eliminate the need to provide an additional optical system for the return path of the penetration monitoring laser beam.

In some embodiments the penetration monitoring laser optical system is arranged such that the penetration monitoring laser beam passes through it before it passes through the common optical system on its path to the process site. In this way the position of the spot of the penetration monitoring laser beam at the process site relative to the spot of the welding laser beam may be pre-determined by the penetration monitoring laser optical system before the penetration monitoring laser beam enters the common optical system. Thereafter the common optical system may serve to maintain these relative positions.

In some embodiments the welding system is arranged to operate the penetration monitoring laser optical system such that a centre of the penetration monitoring laser beam incident on the process site follows a similar path shape to that of a centre of the welding laser beam incident on the process site as the process site is adjusted in a continuous welding operation. The centre of the penetration monitoring laser beam incident on the process site may be equated with a spot of the penetration monitoring laser beam at the process site. Following a similar path may be advantageous as the position of the molten weld pool, from which it is desired that the penetration monitoring laser beam should be reflected, will depend on the position of the centre of the welding laser beam incident on the process site.

In some embodiments the welding system is arranged to operate the penetration monitoring laser optical system such that a centre of the penetration monitoring laser beam incident on the process site has a positional offset with respect to the centre of the welding laser beam incident on the process site as the process site is adjusted in a continuous curved welding operation. The molten weld pool, from which reflections are desired, may tend, for a given curvature, to have a consistent positional offset from the position of the centre of the welding laser beam incident on the process site.

In some embodiments the positional offset from the centre of the welding laser beam incident on the process site to the centre of the penetration monitoring laser beam incident on the process site is maintained in a substantially 1 o'clock direction when viewed from on overhead position. It has been found that in the case of the welding laser beam following a clockwise curvature, the molten weld pool location (‘weld keyhole’) tends to be offset from the centre of the welding laser beam incident on the process site in a 1 o'clock direction.

In some embodiments the penetration monitoring laser optical system is arranged to allow selective adjustment to a field of view of the penetration monitoring laser beam. This may be of assistance in locating and then focussing in on the molten weld pool.

In some embodiments the welding system is arranged to perform a calibration operation prior to performing a main welding operation, wherein in the calibration operation the welding laser source and penetration monitoring laser source are operated simultaneously with the welding laser beam producing the molten weld pool at the process site and the penetration monitoring laser beam initially operating with a first field of view which is wider than a second field of view with which it operates subsequently within the calibration operation, the data from the receiver while the penetration monitoring laser beam operates with the first field of view being used to determine a location within the process site in which the molten weld pool is located in accordance with the spatial distribution of distance travelled by different parts of the penetration monitoring laser beam, adjusting the penetration monitoring laser optical system to locate the centre of the penetration monitoring laser beam incident on the process site at a position relative to the centre of the welding laser beam incident on the process site such that the penetration monitoring laser beam is substantially at the centre of the molten weld pool and reducing the field of view of the penetration monitoring laser beam to the second field of view.

In some embodiments the main welding operation comprises a continuous welding operation performed with the location of the centre of the penetration monitoring laser beam incident on the process site fixed with respect to the location of the centre of the welding laser beam incident on the process site in accordance with the relative position determined in the calibration operation.

In some embodiments the calibration step is repeated only after a discontinuation in welding. Thus once the calibration step has been used to position the centre of the penetration monitoring laser incident on the process site with respect to the molten weld pool, it may not be performed again during the remainder of a corresponding continuous welding operation. Rather, the molten weld pool may simply be followed (e.g. using the positional offset discussed previously) as the welding laser beam is moved.

In some embodiments the welding laser source is a single-mode laser operating in the infra-red waveband. It may operate within the 1000 nm to 1200 nm waveband.

In some embodiments the monitoring laser source operates between substantially 600 and 800 nm.

In some embodiments the welding laser beam has a spot size between 30 and 45 micro meters at the process site.

In some embodiments the cell terminal comprises steel.

In some embodiments the connector tab comprises copper.

According to yet another aspect of the invention there is provided a laser beam welding method comprising:
a) simultaneously operating a welding laser source and a penetration monitoring laser source in a manner such that a penetration monitoring laser beam from the penetration monitoring laser source is incident on a molten weld pool at a process site comprising an area of contact between a connection tab and a cell terminal, the connection tab and cell terminal to be joined by the welding method, the molten weld pool being created by a welding laser beam from the welding laser source;
b) receiving the penetration monitoring laser beam reflected from the molten weld pool; and
c) outputting in accordance with the received penetration monitoring laser beam, data indicative of the distance travelled by the penetration monitoring laser beam and therefore the penetration of the welding laser beam at the process site.

In some embodiments the method comprises determining whether or not the outputted data indicates that the penetration of the welding laser beam at the process site is within a pre-defined tolerance and where it is not, performing at least one of:
a) discontinuing welding;
b) issuing an alert;
c) adjusting one or more parameters of the welding laser source to adjust the penetration depth of the welding laser beam.

In some embodiments the method comprises redirecting both the welding laser beam and the penetration monitoring laser beam in their paths to the process site using each of at least one mirror of a common optical system.

In some embodiments the method comprises adjusting at least one of the mirrors of the common optical system to alter the position of the process site.

In some embodiments the welding method comprises adjusting both the welding laser beam and the penetration monitoring laser beam in their paths to the process site using each of at least one lens of the common optical system.

In some embodiments the welding method comprises adjusting at least one of the lenses of the common optical system to alter the position of the process site. Additionally or alternatively such adjustment may be made to alter the focus of the welding laser beam and the penetration monitoring laser beam at the process site.

In some embodiments the method comprises adjusting the position of the penetration monitoring laser beam at the process site independently of the positioning of the process site as defined by the welding laser beam, using a penetration monitoring laser optical system provided in addition to the common optical system.

In some embodiments the welding method comprises operating the penetration monitoring laser optical system such that a centre of the penetration monitoring laser beam incident on the process site follows a similar path shape to that of a centre of the welding laser beam incident on the process site as the process site is adjusted in a continuous welding operation.

In some embodiments the welding method comprises operating the penetration monitoring laser optical system such that a centre of the penetration monitoring laser beam incident on the process site has a positional offset with respect to the centre of the welding laser beam incident on the process site as the process site is adjusted in a continuous curved welding operation.

In some embodiments the welding method comprises operating the penetration monitoring laser optical system such that the positional offset from the centre of the welding laser beam incident on the process site to the centre of the penetration monitoring laser beam incident on the process site is maintained in a substantially 1 o'clock direction when viewed from on overhead position.

In some embodiments the method comprises performing a calibration operation prior to performing a main welding operation, wherein the calibration operation comprises: a) simultaneously operating the welding laser source and penetration monitoring laser source with the penetration monitoring laser beam initially having a first field of view which is wider than a second field of view with which it is operated subsequently within the calibration operation and the welding laser source producing the molten weld pool at the process site;
b) determining a location within the process site in which the molten weld pool is located in accordance with the spatial distribution of distance travelled by different parts of the penetration monitoring laser source beam using the received penetration monitoring laser beam while it is operated with the first field of view;
c) adjusting the penetration monitoring laser optical system to locate the centre of the penetration monitoring laser beam incident on the process site at a position relative to the centre of the welding laser beam incident on the process site such that the penetration monitoring laser beam is substantially at the centre of the molten weld pool; and
d) reducing the field of view of the penetration monitoring laser beam to the second field of view.

According to a further aspect of the invention there is provided a controller arranged to perform the method of the previous aspect.

In some embodiments the controller comprises:
an input means arranged to receive data indicative of the distance travelled by the penetration monitoring laser beam and therefore the penetration of the welding laser beam at the process site;
a processing means arranged to determine the penetration of the welding laser beam at the process site; and
an output means arranged to output the determined penetration of the welding laser beam at the process site.

In some embodiments the input means is arranged to receive data indicative of a desired path for the welding laser beam, the processing means is arranged determine control for a laser beam welding system comprising the welding laser source and the penetration monitoring laser source in accordance with the desired path for the welding laser beam and such that the penetration monitoring laser beam is reflected from the molten weld pool and the output means outputs the determined control to the laser beam welding system.

In some embodiments the determination of the control for the laser beam welding system comprises performance of the calibration operation.

According to a still further aspect of the invention there is provided a computer program that, when read by a computer, causes performance of the method as described above.

According to a still further aspect of the invention there is provided a non-transitory computer readable storage medium comprising computer readable instructions that, when read by a computer, cause performance of the method as described above.

According to a still further aspect of the invention there is provided a signal comprising computer readable instructions that, when read by a computer, cause performance of the method as described above.

Any controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. A first controller may be implemented in software run on one or more processors. One or more other controllers may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1a-1c show various views of a cell which may be welded to a connector tab in accordance with embodiments of the invention;

FIG. 2 shows a sectional view of a connector tab and cell to be joined by welding in accordance with an embodiment of the invention;

FIG. 3 shows perspective view of part of a welding laser system in accordance with an embodiment of the invention;

FIG. 4 shows a schematic view of a welding laser system in accordance with an embodiment of the invention;

FIG. 5 shows a keyhole created by a welding laser beam in accordance with an embodiment of the invention;

FIG. 6 shows a weld path and a path of a penetration monitoring laser beam in accordance with an embodiment of the invention; and

FIG. 7 shows a controller in accordance with an embodiment of the invention.

### DETAILED DESCRIPTION

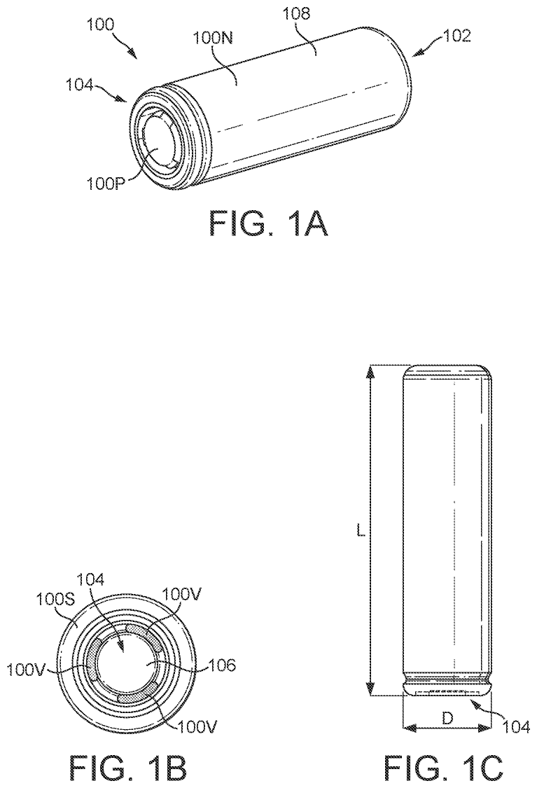

FIGS. 1A-C show different views of a cylindrical cell 100. Cylindrical cells 100 are available in a variety of different sizes. For example, in traction batteries for vehicles cells having a diameter D of 21 mm and a length L of 70 mm are often used. Such cells are typically referred to as 21700 cells (the first two numbers referring to the diameter D, in mm, and the last three numbers referring to the length L, in tenths of mm). However, it will be understood that other sizes of cell may also be used in embodiments of the present invention.

As will be well understood, the cell 100 comprises a positive terminal 100P, a negative terminal 100N, and vent means 100V. The positive terminal 100P is provided by a steel end cap 106 in a central region of a first end 104 of the cell, and the negative terminal 100N is provided by a steel cylindrical case 108. The steel cylindrical case 108 covers the second end 102, the entire cylindrical surface between the first and second ends, and a peripheral region 100S of the first end 104. The peripheral region of the first end surface may also be referred to as a “shoulder” region 100S of the first end 104. In commercially-available cells, it is sometimes the case that the end cap that defines the positive terminal 100P on the first end 104 protrudes beyond the shoulder region of the first end 104, although this is not the case in the cell shown in FIG. 1. This allows a substantially planar connector to be connected to the positive terminal 100P and not the negative terminal 100N. As will be understood, it is important to avoid direct electrical connections between the positive 100P and negative 100S terminals, as such connections create a short circuit which may damage the cell 100.

As shown in FIG. 1, the cell 100 comprises three vent means 100V in the first end 104, between the steel end cap 106 that defines the positive terminal 100P and the shoulder region 100S of the steel cylindrical case 108. The vent means 100V are gaps that are covered by a material that will rupture to allow hot gases to escape through the gap between the end cap 106 and steel cylindrical case 108 in the event of excessive pressure occurring inside the cell, thereby mitigate against the risk of the cell 100 exploding.

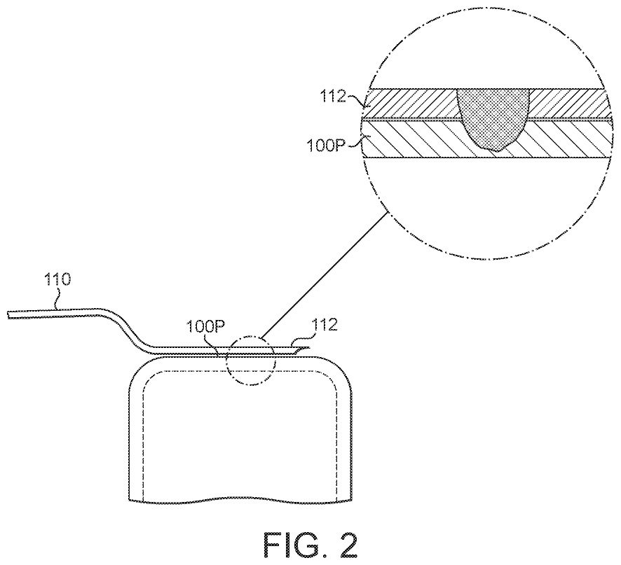

It may be desired to incorporate multiple examples of the cell 100 into a battery module. In this case it may be that the positive terminals 100P of the cells 100 are connected in parallel by a positive busbar 110 connected to each positive terminal 100P by respective connection tabs 112 of the positive busbar 110 (see FIG. 2). Similarly the negative terminals 100N of the cells 100 are connected in parallel by a negative busbar connected to each negative terminal 100N by respective connection tabs of the negative busbar. The connection of each connection tab to its respective terminal 100P, 100N may be by laser welding. The laser welding may be performed through the connection tab overlaying the connection terminal to join the two. In one particular case the terminals 100P, 100N are of steel and the connection tabs are of copper. Such arrangements may have particularly fine margins in terms of appropriate welding laser beam operational parameters if under and over penetration of the welding laser beam is to be avoided. Specifically, copper, in the infra-red waveband, reflects more of the welding laser beam than steel does, and so absorbs less energy. Accurate and/or timely and/or cost-effective analysis of weld depth penetration may therefore be still more significant than would otherwise be the case.

The welding process is performed by a welding system having particular adaptations to allow real-time monitoring of the penetration depth into the connection tab and (where sufficient penetration is achieved) the terminal 100P, 100N. More specifically the welding system comprises not only a welding laser source, but also a penetration monitoring laser source arranged to deliver a penetration monitoring laser beam separate to the welding laser beam. The penetration monitoring laser beam is used to monitor the penetration depth of the welding laser beam.

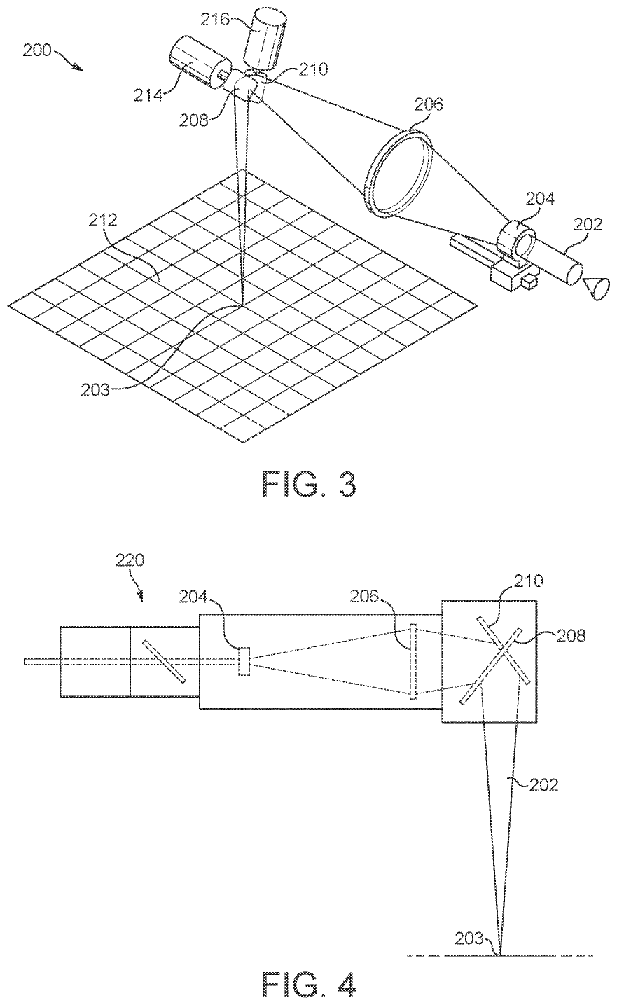

Referring now to FIGS. 3 and 4 a laser beam welding system is generally shown at 200. The system 200 comprises a welding laser source (not shown), which produces a welding laser beam 202 and a penetration monitoring laser source (not shown) which produces a penetration monitoring laser beam (not shown). By means described further below, the system 200 delivers the welding laser beam 202 to a process site 203 defined as an area of the relevant connection tab, and through it the cell terminal, upon which the welding laser beam 202 is incident at the relevant time. The system 200 simultaneously delivers the penetration monitoring laser beam (not shown) to the process site 203. At the point of its interception of the process site 203, the welding laser beam may be considered to define or generate a spot of the welding laser beam 202. Similarly at the point of its interception of the process site 203, the penetration monitoring laser beam may be considered to define or generate a spot of the penetration monitoring laser beam.

The system 200 comprises a common optical system via which both laser beams pass from their respective sources (not shown) to the process site 203. The common optical system comprises, in sequential order from the sources (not shown) to the process site 203, a diverging lens 204, a converging lens 206, a first mirror 208 and a second mirror 210. Each of the mirrors 208, 210 is rotatable about a single axis under the control of a respective galvanometer 214, 216. The axes about which the mirrors 208, 210 are rotated are mutually perpendicular, so that the first mirror 208 controls the location of the process site 203 with respect to the X-axis direction and the second mirror 210 controls the location of the process site with respect to the Y-axis direction. The adjustment of the first 208 and second mirrors 210 also respectively influence the X-axis direction positioning and Y-axis direction positioning of the penetration monitoring laser beam at the point where it intersects the process site 203. The diverging lens 204 is movable along an axis parallel to the initial direction of the welding laser beam 202 and may therefore be considered an adjustable focussing lens. This allows the position of the focal points of both the welding laser beam 202 and the penetration monitoring laser beam (not shown) to be adjusted in the Z-axis direction. It will be appreciated that in other embodiments the order of the provision of the various components of the common optical system may be adjusted (for instance the order of the first 208 and second 210 mirrors may be reversed).

In addition to the common optical system the system 200 also has a penetration monitoring laser optical system 220 via which the penetration monitoring laser beam (and not the welding laser beam 202) passes from the penetration monitoring laser source to the process site 203, and in this case, first to the common optical system. The penetration monitoring laser optical system 220 comprises mirrors to adjust the alignment of the penetration monitoring laser beam to that of the welding laser beam 202 and a manual adjustment screw to adjust the focus of the penetration monitoring beam. These provide optical conditioning of the penetration monitoring laser beam in addition to that provided by the common optical system. Because the precise positioning of the penetration monitoring laser beam relative to the welding laser beam 202 is adjustable, the penetration monitoring laser optical system 220 allows selective positional adjustment of the penetration monitoring laser beam at the process site 203 independently of the positioning of the welding laser beam 202 at the process site 203.

In the present embodiment the welding laser source is a single-mode infra-red laser operating at substantially 1070 nm wavelength. It is controlled to emit the welding laser beam 202 in a discontinuous manner, in this case in periodic bursts. The power of the welding laser beam emitted is substantially 600 W.

The common optical system (and specifically the diverging lens 204 position) is controlled to focus the welding laser beam 202 at a desired position with respect to the Z-axis direction. In most cases the welding laser beam 202 will be focussed at or near to the process site 203 and will have a spot size between 30 and 45 micro meters at the process site 203.

Focussing at a point other than the process site may be advantageous in certain regards e.g. in controlling penetration and/or reducing sputter. The common optical system (and specifically the diverging lens 204 position) is controlled to compensate for angular adjustments of the welding laser beam 202 (e.g. as resulting from X-axis and/or Y-axis position adjustments of the welding laser beam 202) in maintaining the desired focus at the process site 203.

The common optical system (and specifically the first 208 and second 210 mirrors) is controlled to steer the welding laser beam 202 in order that it perform a continuous welding operation (i.e. having a substantially continuous weld path) so that the weld path is a substantially continuous loop completed in a clockwise direction. In addition, The common optical system (and specifically the first 208 and second 210 mirrors) is controlled to steer the welding laser beam 202 to oscillate about the weld path wherein the oscillations comprise a first component in a direction parallel to the weld path and a second component in a direction normal to the weld path.

The common optical system (and specifically the first 208 and second 210 mirrors) is controlled to steer the welding laser beam 202 for re-siting of the welding laser beam 202 e.g. as appropriate when commencing a new continuous welding operation at a new location, for example when welding a second or subsequent connector tab, terminal pair.

As will be appreciated, the common optical system may also have a similar focussing and steering effect on the penetration monitoring laser beam, though additional focussing and steering control over the penetration monitoring laser beam is performed by the penetration monitoring laser optical system 220 as required (discussed further below).

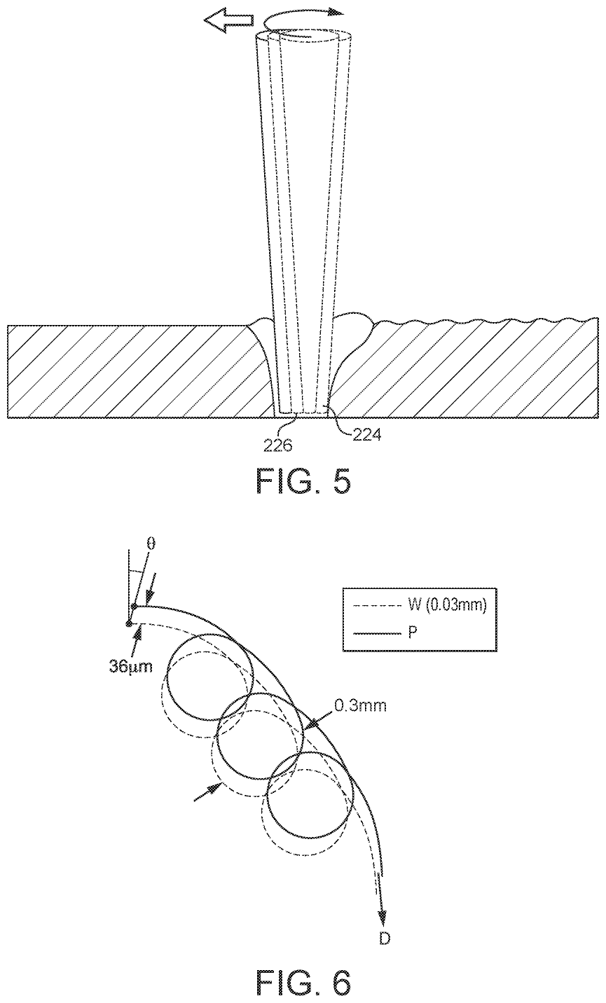

The welding laser beam 202 creates a cavity known as a keyhole 224 as it locally melts material of the connector tab and terminal (see FIG. 5). The keyhole 224 moves with the spot of the welding laser beam 202. At the base of the keyhole 224 is a molten weld pool 226. To the extent that the penetration monitoring laser beam is directed to be properly incident on the molten weld pool 226, it is reflected therefrom. Where this reflected penetration monitoring laser beam is subsequently detected, the time taken between emission of the penetration monitoring laser beam and its detection can be used to determine the distance travelled by the penetration monitoring laser beam (as dependent on the depth of the molten weld pool 226) and therefore the penetration of the welding laser beam 202 at the process site 203. To this end the system 200 comprises a receiver (not shown) arranged to receive the reflected penetration monitoring laser beam on its return path.

The receiver is located to receive the reflected penetration monitoring laser beam after it has passed back through the common optical system and the penetration monitoring laser optical system. In addition, the receiver may be mounted on a scanning head, positionally adjustable with respect to the penetration monitoring laser source. Movements of this scanning head may be conducted in order to assist in receiving the reflected penetration monitoring laser beam at the receiver. The mirrors of the common optical system (the first 208 and second 210 mirrors) are provided with a fused silica coating, such that they thereby better facilitate the reflection of the penetration monitoring laser beam back towards the converging 206 and diverging 204 lenses, penetration monitoring laser optical system and receiver. This may be contrasted with the provision of a silicon carbide coating which may more conventionally be provided. Mitigation of damage which might be caused by at least partial absorption of the reflected welding laser beam at the lenses 204, 206 and welding laser source etc (through heating and ultimately cracking) may be achieved by various measures. The measures may be the comparatively low power of the welding laser beam 202 (approximately 600 W), a comparatively large distance between the second 210 mirror and the process site 203 (approximately 300-350 mm) and the discontinuous nature of the delivery of the welding laser beam 202. The penetration monitoring laser beam itself is delivered by the penetration monitoring laser source at a wavelength between substantially 600 and 800 nm and at a power sufficiently low as not to interact (i.e. cause any significant heating) with the process site 203.

In the present embodiment the penetration monitoring laser optical system 220 is operated to initially fine tune the position of the spot of the penetration monitoring laser beam to the location of the molten weld pool 226 in a calibration operation. Thereafter the penetration monitoring laser optical system 220 is no longer adjusted throughout the remainder of an associated continuous welding operation. Further, the common optical system adjusts the locations of the spots of the welding laser beam 202 and penetration monitoring laser beam in tandem, with a fixed offset distance and directional offset between them as previously determined by the penetration monitoring laser optical system 220 in the calibration operation.

During the calibration operation, prior to performing the main welding operation, the welding laser source and penetration monitoring laser source are operated simultaneously with the welding laser beam producing the molten weld pool 226 at the process site 203 and the penetration monitoring laser beam initially operating with a first field of view which is wider than a second field of view with which it operates subsequently within the calibration operation. Field of view adjustments necessary in order to achieve the first and second fields of view are performed by the penetration monitoring laser optical system 220. Data from the receiver while the penetration monitoring laser beam operates with the first field of view is used to determine a location within the process site 203 in which the molten weld pool 226 is located in accordance with the spatial distribution of distance travelled by different parts of the penetration monitoring laser beam. The penetration monitoring laser optical system 220 is then adjusted based on the determined location. Specifically, the centre of the penetration monitoring laser beam incident on the process site 203 is adjusted to a position relative to the centre of the welding laser beam 202 incident on the process site 203 such that the penetration monitoring laser beam is substantially at the centre of the molten weld pool 226. Additional adjustment is made by the penetration monitoring laser optical system 220 to reduce the field of view of the penetration monitoring laser beam to the second field of view. The second field of view may be limited to within the confines of the keyhole 224 and/or molten weld pool 226.

Thereafter, the main welding operation is performed comprising a continuous welding operation as previously described with both the welding laser beam 202 and penetration monitoring laser beam operating simultaneously. Throughout the main welding operation, a fixed distance offset and directional offset between the spot of the welding laser beam 202 and the spot of the penetration monitoring laser beam is faithfully maintained during positional adjustment by the common optical system (affecting both beams similarly). Assuming therefore that the molten weld pool 226 generated by the welding laser beam remains at a substantially consistent location with respect to the welding laser beam spot as it moves, the penetration monitoring laser beam spot should remain incident on the molten weld pool 226. As a consequence of the common optical system, the spot of the penetration monitoring laser beam follows a similar path shape to the spot of the welding laser beam 202 (see FIG. 6). In the specific example of FIG. 6, the distance offset of the spot of the penetration monitoring laser beam (shown at P) is maintained at substantially 36 μm and its directional offset in a substantially 1 o'clock direction with respect to the spot of the welding laser beam (shown at W) when viewed from on overhead position.

In this embodiment the calibration step is repeated only after a discontinuation in welding, e.g. to move to a new welding site such as a different connection tab and terminal combination.

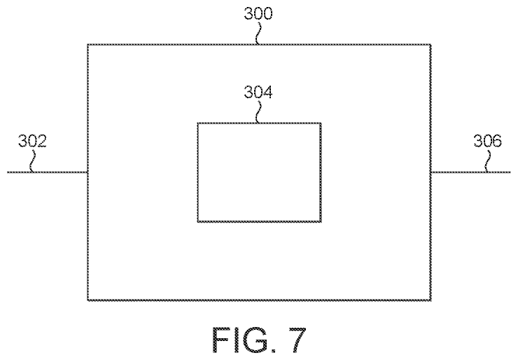

In the present embodiment the various controllable operations discussed above are controlled by a controller 300 (see FIG. 7). The controller 300 has an input means 302, a processor means 304 and an output means 306. In this case the controller 300 is operable to control the power of the welding laser beam and to selectively switch the welding laser beam on and off via control of the welding laser source. The controller 300 is also operable to selectively switch on and off the penetration monitoring laser beam via control of the penetration monitoring laser source. The controller 300 is also operable to adjust the focal positions of the laser beams by moving the diverging lens 204, and to adjust positions of the spots of the respective laser beams by controlling the angular positions of the first and second mirrors 208, 210 via the respective galvanometers 214, 216 and in the case of the penetration monitoring laser beam, also the penetration monitoring laser optical system. The controller 300 is also operable to move the scanning head of the receiver. As will be appreciated, suitable inputs are received by the controller 300 and in particular the processing means 304 via the input means 302 in order to instruct such control and/or in order that such controls may be calculated by the processing means 304. Such inputs may for instance have been programmed by a user or system and may be inputted via the input means 302 from a memory, a server, direct user input on a user interface or the like. Accordingly, the controller 300 may for example be programmed to perform a predetermined weld or set of welds each with a particular weld path and/or oscillations by actuating the welding laser beam accordingly and simultaneously monitoring the penetration of the welding laser beam. As will be appreciated outputs are output from the controller 300, and in particular the processing means 304, via the output means 306. Such outputs may for instance include signals sent to the welding beam laser source, penetration monitoring laser source, the common optical system and/or specific of its component parts and/or the penetration monitoring laser optical system and/or specific of its component parts.

Further and specifically, the input means receives, from the receiver, data indicative of the distance travelled by the penetration monitoring laser beam. This is used by the processing means 304 for performance of the calibration operation and thereafter for monitoring the penetration of the welding laser beam 202 at the process site 203. During the main welding operation the processing means 304 calculates the penetration of the welding laser beam 202 and outputs this penetration for display.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine-readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A laser beam welding system comprising:
a welding laser source; and
a penetration monitoring laser source,
arranged for simultaneous operation in a manner such that a penetration monitoring laser beam from the penetration monitoring laser source is incident on a molten weld pool at a process site comprising an area of contact between a connection tab and a cell terminal, the connection tab and cell terminal to be joined by the laser beam welding system, and wherein the molten weld pool is created by a welding laser beam emitted by the welding laser source, and the penetration monitoring laser beam being reflected from the molten weld pool to a receiver arranged to receive the reflected penetration monitoring laser beam and in accordance therewith, output data indicative of a distance travelled by the penetration monitoring laser beam and therefore the penetration of the welding laser beam at the process site.

2. The laser beam welding system according to claim 1 where the laser beam welding system comprises a common optical system comprising at least one mirror, wherein each of the at least one mirror is arranged to redirect both the welding laser beam and the penetration monitoring laser beam in their paths to the process site.

3. The laser beam welding system according to claim 2 where at least one of the at least one mirror of the common optical system comprises an adjustable mirror arranged to be selectively adjustable to alter a position of the process site.

4. The laser beam welding system according to claim 2 where the common optical system comprises at least one lens wherein each of the at least one lens is arranged to adjust both the welding laser beam and the penetration monitoring laser beam in their paths to the process site.

5. Pin The laser beam welding system according to claim 2 where the common optical system is arranged to produce a weld path of the welding laser beam which is a continuous loop.

6. Pin The laser beam welding system according to claim 2 where the laser beam welding system comprises a penetration monitoring laser optical system in addition to the common optical system and the penetration monitoring laser beam passes through the penetration monitoring laser optical system on its path to the process site.

7. Pin The laser beam welding system according to claim 6 where the laser beam welding system is arranged to operate the penetration monitoring laser optical system such that a centre of the penetration monitoring laser beam incident on the process site:
follows a similar path shape to that of a centre of the welding laser beam incident on the process site as the process site is adjusted in a continuous welding operation; or
has a positional offset with respect to the centre of the welding laser beam incident on the process site as the process site is adjusted in a continuous curved welding operation.

8. The laser beam welding system according to claim 6 where the penetration monitoring laser optical system is arranged to allow selective adjustment to a field of view of the penetration monitoring laser beam.

9. The laser beam welding system according to claim 8 where the laser beam welding system is arranged to perform a calibration operation prior to performing a main welding operation, wherein in the calibration operation the welding laser source and penetration monitoring laser source are operated simultaneously with the welding laser beam producing the molten weld pool at the process site and the penetration monitoring laser beam initially operating with a first field of view which is wider than a second field of view with which it operates subsequently within the calibration operation, the data from the receiver while the penetration monitoring laser beam operates with the first field of view being used to determine a location within the process site in which the molten weld pool is located in accordance with a spatial distribution of distance travelled by different parts of the penetration monitoring laser beam, adjusting the penetration monitoring laser optical system to locate a centre of the penetration monitoring laser beam incident on the process site at a position relative to a centre of the welding laser beam incident on the process site such that the penetration monitoring laser beam is substantially at a centre of the molten weld pool and reducing the field of view of the penetration monitoring laser beam to the second field of view.

10. The laser beam welding system according to claim 7 where a main welding operation comprises a continuous welding operation performed with a location of the centre of the penetration monitoring laser beam incident on the process site fixed with respect to a location of the centre of the welding laser beam incident on the process site in accordance with a relative position determined in a calibration operation.

11. A laser beam welding method comprising:
a) simultaneously operating a welding laser source and a penetration monitoring laser source in a manner such that a penetration monitoring laser beam from the penetration monitoring laser source is incident on a molten weld pool at a process site comprising an area of contact between a connection tab and a cell terminal, the connection tab and cell terminal to be joined by the laser beam welding method, the molten weld pool being created by a welding laser beam from the welding laser source;
b) receiving the penetration monitoring laser beam reflected from the molten weld pool; and
c) outputting in accordance with the received penetration monitoring laser beam, data indicative of a distance travelled by the penetration monitoring laser beam and therefore the penetration of the welding laser beam at the process site.

12. The laser beam welding method according to claim 11 comprising redirecting both the welding laser beam and the penetration monitoring laser beam in their paths to the process site using each of at least one mirror of a common optical system.

13. The laser beam welding method according to claim 12 comprising adjusting a position of the penetration monitoring laser beam at the process site independently of positioning of the process site as defined by the welding laser beam, using a penetration monitoring laser optical system provided in addition to the common optical system;
optionally the laser beam welding method further comprising performing a calibration operation prior to performing a main welding operation, wherein the calibration operation comprises:
a) simultaneously operating the welding laser source and penetration monitoring laser source with the penetration monitoring laser source initially having a first field of view which is wider than a second field of view with which it is operated subsequently within the calibration operation and the welding laser source producing the molten weld pool at the process site;
b) determining a location within the process site in which the molten weld pool is located in accordance with a spatial distribution of distance travelled by different parts of the penetration monitoring laser source beam using the received penetration monitoring laser beam while it is operated with the first field of view;
c) adjusting the penetration monitoring laser optical system to locate a centre of the penetration monitoring laser beam incident on the process site at a position relative to a centre of the welding laser beam incident on the process site such that the penetration monitoring laser beam is substantially at a centre of the molten weld pool; and
d) reducing a field of view of the penetration monitoring laser beam to the second field of view.

14. A controller arranged to perform the laser beam welding method of claim 11.

15. A computer program stored in a non-transitory storage medium that, when executed by a computer, causes the computer to perform the laser beam welding method as claimed in claim 11.

16. The laser beam welding system according to claim 2 where the receiver is arranged to receive the reflected penetration monitoring laser beam with it having been reflected from the molten weld pool and then reflected by the one, some or all of the at least one mirror of the common optical system.

17. The laser beam welding system according to claim 4 where at least one of the at least one lens of the common optical system comprises an adjustable lens arranged to be selectively adjustable to alter a position of the process site.

18. The laser beam welding system according to claim 5 where the common optical system is arranged to produce oscillations about the weld path, wherein the oscillations comprise a first component in a direction parallel to the weld path and a second component in a direction normal to the weld path.

19. The laser beam welding system according to claim 6 where the penetration monitoring laser optical system is arranged to allow selective positional adjustment of the penetration monitoring laser beam at the process site independently of positioning of the process site as defined by the welding laser beam.

20. The laser beam welding method according to claim 12, further comprising adjusting at least one of the at least one mirror of the common optical system to alter a position of the process site.
